(19) United States
(12) Patent Application Publication
(10) Pub. No.: US 2007/0033211 A1
(43) Pub. Date: Feb. 8, 2007

(54) Mergers and acquisitions using component business model

(76) Inventors: Saul J. Berman, Los Angeles, CA (US); David Robert Kress, Carmel, IN (US); Jeffrey A. Neville, Chicago, IL (US); George Edmund Pohle, Morristown, NJ (US); Guy Jonathan James Rackham, New York, NY (US); Stephen Michael Smith, Westlake Village, CA (US); Laurie A. Tropiano, Old Greenwich, CT (US); Stephen Wood, Harrogate (GB)

Correspondence Address: WHITHAM, CURTIS & CHRISTOFFERSON, P.C., 11491 SUNSET HILLS ROAD, SUITE 340, RESTON, VA, 20190, US

(21) Appl. No.: 11/196,484

(22) Filed: Aug. 4, 2005

(51) Int. Cl. G06F 7/00

(52) U.S. Cl. 707/102

(57) ABSTRACT

A method of combining businesses by creating a target component map based on the business strategy of the resulting company, and using that target map to generate a component map for each constituent company in the combination. The constituent component map describes the current state of each component instantiated in the constituent company. Where there is no overlap between constituent companies with respect to components in the target map, those component instantiations are carried over to the resulting company. Where there is overlap, a comparative analysis is done and a ‘best fit’ component is recommended for inclusion in the resulting company. A transformation plan is developed to build the resulting company from those component instances selected for inclusion, in accordance with the target component map. Where the business strategy for building the resulting company includes a divestiture, the transformation plan provides alignment of the components to be divested in order to optimize the divestiture.

This invention is related to commonly owned patent application Ser. No. 11/176,371 for “SYSTEM AND METHOD FOR ALIGNMENT OF AN ENTERPRISE TO A COMPONENT BUSINESS MODEL” which is incorporated by reference herein.

### BACKGROUND OF THE INVENTION

1. Field of the Invention

The present invention generally relates to component based business models and, more particularly, to techniques for using a component business model to structure mergers and acquisitions.

2. Background Description

When companies go through mergers and acquisitions, it's not easy to see how all parts of the organizations will come together to create a new organization, and it's often very difficult to evaluate two relatively similar capabilities in different organizations to see which one you should have in the future (based on business strategies, regulatory requirements, competitive nature of the industry, etc). Mergers and acquisitions are generally driven by fairly high level judgments by key players regarding the overall aspects of the combined company. But the companies combined on that basis often fail to meet the expectations of the key players. The high level judgments that justified going forward with the combination do not always survive the necessary details of implementing the combination. In the prior art, there is no comprehensive lens through which different companies in the combination can be subjected to a common view.

What is needed is a methodology that provides a consistent and comprehensive analysis of the companies to be combined, using a common framework that will support both the high level judgments and the implementation details required for an effective combination.

### SUMMARY OF THE INVENTION

It is therefore an object of the invention to provide an analysis of the constituent parts of a business in terms that can be correlated with the constituent parts of another business, so an evaluation can be made of the corresponding constituent parts of a combined business.

Another object of the invention is to provide a framework for translation between high level views of businesses to be combined and practical implementation at the level of constituent parts of the combined business.

A further object of the invention is to provide a systematic mechanism for analysis of the constituent parts of businesses to be combined, for determining at the constituent part level whether a particular constituent part of one business is to be included, excluded, or combined with a corresponding constituent part of the other business in the combination.

The invention uses the Component Business Model (CBM) described in related patent application Ser. No. 11/176,371 for “SYSTEM AND METHOD FOR ALIGNMENT OF AN ENTERPRISE TO A COMPONENT BUSINESS MODEL” (hereafter termed “the above referenced foundation patent application”). CBM provides a logical and comprehensive view of the enterprise, in terms that cut across commercial enterprises in general and industries in particular. The component business model as described in the above referenced foundation patent application is based upon a logical partitioning of business activities into non-overlapping managing concepts, each managing concept being active at the three levels of management accountability: providing direction to the business, controlling how the business operates, and executing the operations of the business. The term “managing concept” is specially defined as described in the above referenced foundation patent application, and is not literally a “managing concept” as that phrase would be understood in the art. For the purpose of the present invention, as for the related invention, “managing concept” is the term associated with the following aspects of the partitioning methodology. First, the methodology is a partitioning methodology. The idea is to begin with a whole and partition the whole into necessarily non-overlapping parts. Second, experience has shown that the partitioning process works best when addressed to an asset of the business. The asset can be further described by attributes. Third, the managing concept must include mechanisms for doing something commercially useful with the asset. For a sensibly defined managing concept these mechanisms must cover the full range of management accountability levels (i.e. direct, control and execute). Managing concepts are further partitioned into components, which are cohesive groups of activities. The boundaries of a component usually fall within a single management accountability level. It is important to emphasize that the boundaries between managing concepts (and between components within managing concepts) are logical rather than physical.

Using the component business model, business managers can go through the process of first creating a new future state design for a merged organization. That is, they develop an ideal component business model structure based on a strategy for the merged company. They then use CBM to analyze each of the components in the existing companies to create the overall merger strategy. Each component in the target component map of the merged organization is evaluated and compared against similar components in the existing organizations (looking at people, technology, resources, business knowledge) and then the components in the existing organizations are either merged in, transformed or eliminated. This methodology allows a fairly agnostic and value-based analysis of which parts of the original organizations should get incorporated into the new organization. Likewise, this approach also works for evaluating the components of a business one company buys and merges into another (so it's not a “new” company being created but an existing one being modified).

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a flow diagram showing the method of the invention.

FIG. 2 is a component map of an exemplar target company resulting from the merger of exemplar company A and exemplar company B in a merger scenario.

FIG. 3 is a conceptual overlay of an exemplar Company A in a merger scenario upon the target map shown in FIG. 2.

FIG. 4 is a conceptual overlay of exemplar Company B in a merger scenario upon the target map shown in FIG. 2.

FIG. 5 is a schematic diagram showing the execution of a transformation plan merging exemplar Company A and exemplar Company B into an exemplar target company.

FIG. 6A shows in conceptual form the combined overlays of the exemplar Company A shown in FIG. 3 and exemplar Company B shown in FIG. 4 upon the target map shown in FIG. 2.

FIGS. 6B through 6E highlight those components as shown in FIG. 6A unique to Company A (FIG. 6B), unique to Company B (FIG. 6C), contained in both Company A and Company B (FIG. 6D), and contained in neither Company A nor Company B (FIG. 6E).

### DETAILED DESCRIPTION OF A PREFERRED EMBODIMENT OF THE INVENTION

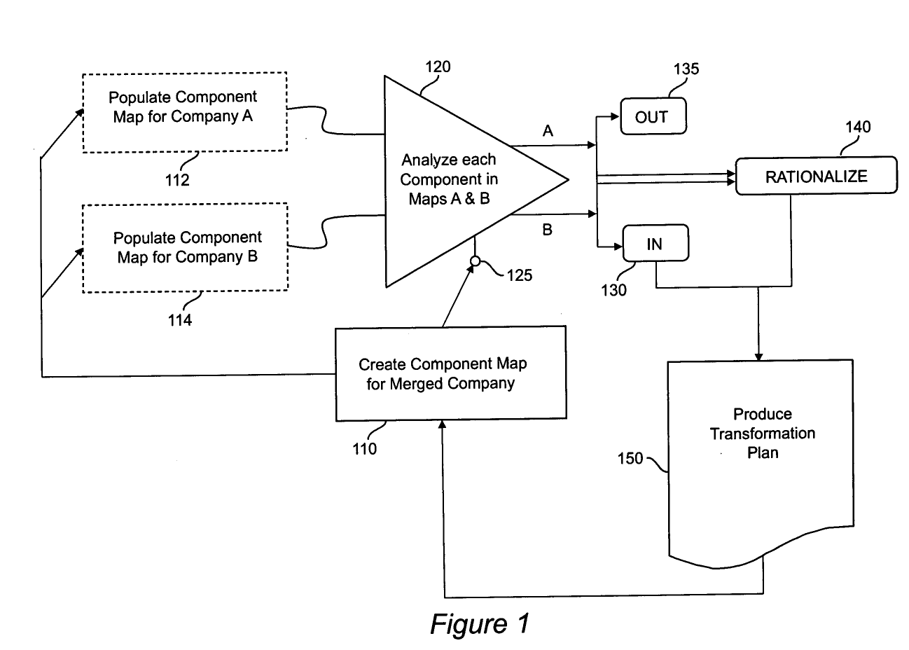

The method of the invention may be understood with reference to FIG. 1. The object of the invention is to support the creation of the merged company that combines Company A and Company B. The first step, therefore, is to create a target component map 110 for the merged company. This map is then used as the model for creating component maps for each of the companies that are merging, in this example a component map 112 for Company A and a component map 114 for Company B.

Each of these component maps (110 for the merged company, 112 for Company A and 114 for Company B) are prepared using the approach described in the above referenced foundation patent application. That is, the component map created reflects the target state of the company desired by company management. For the purposes of a merger or acquisition, however, the target state (112 and 114) for the companies to be combined is the same as the target state 110 of the company resulting from the merger or acquisition.

Using the common target state as a framework for gathering information, the component maps for Company A and Company B will be populated with details sufficient to show the current state of these companies with respect to the target state 110 of the merged company. In an alternative implementation of the invention, where either or both Company A and Company B have existing component maps, the details showing the current state of the company are already present, and the task of creating a component map in conformity with the target component map 110 is a matter of revising the existing component map to reflect the revised strategies of the combined company. In most merger and acquisition contexts, this would involve adding components or component instances to the map. In mergers or acquisitions which involve combining businesses from different industries (so called “conglomerate mergers”), this may involve adding entire competencies and the components associated with these competencies. In those situations, the added competencies and components may have no supporting details in at least one of the existing companies.

In a complex merger or acquisition, the strategy being pursued by the managers of the resulting business may include dropping some component instances or even (in a reverse of a “conglomerate merger”) entire competencies. For example, regulatory considerations may require that a line of business be divested as a condition of the merger. In such situations the reverse condition applies, that is, there may be supporting detail in the current state of the company that has no home in a component of the resulting company. In order to maintain a complete description, the component map of Company A 112 or the component map of Company B 114 would include component instances and competencies not contained in the target component map. It should be noted that components in the CBM model are relatively coarse grained, so that differences within industries generally may be accounted for by different instantiations of the same generic component, and that only mergers and acquisitions across industries would be likely to involve different competencies between the component maps of Company A 112 and Company B 114.

In any event, the result will be that both the component map of Company A 112 and the component map of Company B 114 will include all the competencies and components of a common target component map of the combined company 110. These respective component maps will contain detail showing the current state of Company A and Company B with respect to a target state 110 of the merged company. However, the “current state” of the merged company is not determined until the analysis stage 120 and, in one implementation of the invention, the “current state” of some components of the merged company are not fully determined until development of the transformation plan 150. In principle, component map 112 for Company A (and, similarly, component map 114 for Company B) will have sufficient detail regarding both the current state of the company and the attributes of the target state to permit an assessment of what is required for each component in order to align the company to the common target component map.

For example, a particular component needed for the merged company—and therefore on the Company A component map—may have nothing in its current state to support the target state component, indicating that an effective instance of that component is not present in Company A at all. A strategy for migrating Company A to the target component map would require creation of the attributes necessary for an effective instance of the component. If Company B has that component, an examination of Company B's current state will show whether the requirements of the target state are already met, or whether there are shortfalls. If there are shortfalls, the strategy for migrating Company B would involve providing the component with the attributes and capabilities required to overcome the shortfalls between the current state of the component in Company B and the target state of the component.

The analysis 120 is undertaken in view 125 of the target state of the combined company. The analysis 120 of the alternative strategies for a particular component available from the component instance shown in the Company A component map 112 and the Company B component map 114 will produce a recommendation as to which instance is better suited to the target state of the combined company. If there is no effective instance of the component in the Company A component map 112, the likely recommendation will be inclusion 130 of the component instance that exists in the Company B component map 114 and discarding 135 the component instance from the Company A component map 112 that does not effectively exist in the current state of Company A. The same logic applies to a component instance which does not effectively exist in the Company B component map 114 but is present in the Company A component map 112.

A similar analysis 120 will be applied when both Company A and Company B have instances of the component. In that situation the likely outcome will be to rationalize 140 the assets involved in the two instances of the component. This rationalization 140 may be an output of analysis 120, or may be undertaken as part of development of the transformation plan 150. In either implementation of the invention, if the component in Company A is recommended as having the most desirable migration strategy for alignment with the target component, then the resources from the corresponding component in Company B may be applied to the migration strategy for Company A, to the extent needed, and otherwise disposed of. And, as before, the same logic applies where the recommended component instance is taken from the Company B component map 114, and the assets associated with the instance of the component map 112 of Company A are applied to the migration strategy for Company B.

For example, suppose that a “correspondence” component is implemented in both Company A and Company B by a mail room, and in both Company A and Company B there are two employees in the mail room. If the corresponding component in the target component map 110 requires three employees in one location and two employees in another location, then the two employees in Company B would be used, plus a third new hire. On the other hand, suppose that the mail room is supported by a mail handling application program, and Company A has the superior mail handler. In that case the mail handler of Company B would be discarded and the mail room employees of Company B would be trained on the Company A mail handler application program. Note that the CBM model provides for displaying the footprint of computer applications across the component map, so that the full context of the mail handler application will be evident in the analysis 120. If the superior Company A mail handler program is limited to mail handling, but mail handling in Company B is part of an integrated application that is superior to the systems support being provided to Company A, then it may be a preferred alternative—as viewed from the point of view 125 of the merged company as a whole—to use the integrated application from Company B. The component map and the CBM techniques (as described in the above referenced foundation patent application) for constructing and evaluating overlays on the component map provide an effective way of visualizing these alternatives.

As a further alternative for analysis 120, suppose that the Company A “correspondence” component is implemented by a robotic mail handler and the corresponding component in the target component map requires a robotic mail handler, whereas Company B has a mail room with two employees. In that case, the analysis 120 could conclude that the mail room instantiation of the “correspondence” component should be discarded 135 and that there is no basis for rationalizing the mail room employees of Company B (although they might be suitable for positions elsewhere in the merged company).

Comparisons between the components of Company A and the components of Company B will be done on the basis of i) people skills and backgrounds, ii) technology (which systems and applications are in place, how strongly do they meet the future design requirements, can they be easily adapted, can duplications be eliminated), iii) resources (does one component have access to unique resources—land, buildings, contracts that are unique), iv) compliance with regulatory requirements (like Sarbanes-Oxley), v) the relative efforts and resources needed to align the current state of the respective components with the target, and other pertinent criteria. Scores are given for each criterion and an evaluation metric based on these scores is optimized for the components of the merged company.

The above description considers several alternatives in the component by component analysis 120. Company A's instantiation of the component may be included 130 as a ‘best fit’, and Company B's instantiation of the component may be excluded 135. Or Company B's instantiation of the component may be included 130 as a ‘best fit’, and Company A's instantiation of the component may be excluded 135. The assets associated with an excluded component may be incorporated by rationalization 140.

In a complex merger or acquisition involving a divestiture, a further alternative is that a component, from either component map 112 of Company A or component map 114 of Company B is excluded 135 because the component itself is not included in the component map for the merged company.

It will be observed by those skilled in the art that business managers controlling the merger process may apply additional strategic considerations for selecting an alternative other than the recommended alternative, but the results of the analysis 120 provides a roadmap and a complete inventory of the capabilities being put together in the new organization.

Once the “current state” of the components assigned to the new organization have been identified, a specific transformation plan is created 150 for each part of the business. For those components that were taken in 130 from either Company A or Company B, the transformation plan may be very similar to the plan needed to align the component in the source company to the state of the target component, except that certain assets (available because certain components were discarded 135) may be preferred to outside sources in the transformation plan. For those components that are part of the plan as a consequence of being rationalized 140, the “current state” in the merged company will be different from the current state in either Company A or Company B. For example, if the component from Company A is the preferred recommendation, the rationalization 140 may add elements from the Company B component, thereby giving the component a more advantageous position going into the development of a transformation plan 150.

Those skilled in the art will observe that an alternative implementation of the invention would defer rationalization 140 to the development of transformation plan 150. That is, analysis 120 would recommend the component instance of Company A or Company B as the ‘best fit’ for the merged company. Then the selected component instance would be taken IN 130, and the non-selected component would be left OUT 135. The assets associated with component instances left OUT 135 are then available for implementing the transformation plan 150.

The transformation plan 150 will include specific organizational plans (often new employment contracts, incentive systems, reporting structures), transformation of technology into the new environment (often moving to a service-oriented architecture or moving data/systems onto newly agreed upon shared platforms), movement of additional resources, etc. This process generally requires significant expertise from consultants that specialize in organizational consulting, technology consulting, business design, etc. The analysis output provided by the invention substantially enables these further decisions.

If the merger makes sense, the transformation plan 150 will be an improvement upon comparable plans for alignment of either Company A or Company B. Indeed, for the purposes of such a comparison, the invention may be used to generate transformation plans for an alignment of Company A by placing a null set in the component “current state” details for Company B, and a transformation plan for an alignment of Company B may be generated in the same way. Metrics applied to such generated plans and the transformation plan 150 for the merged company can be used to verify that the merger approach is superior to the alternatives of building upon Company A separately or Company B separately to achieve the target component map. Or, in addition to verification, such analysis may provide insights that suggest modifications in the component map 110 for the merged company. Thus the invention can be used iteratively to refine the assessment and evaluation of a merger.

The foregoing description of the invention has used a merger scenario where Company A and Company B are merging. However, it will be readily evident that the same description and teachings can be applied to the acquisition of Company A by Company B, or vice versa. In general, as output from analysis 120, there will be a mix of a) components which have no counterpart in the other company and are simply ‘slotted in’ 130 to the new organization without needing a comparative analysis, b) components which are carried over to the new organization after analysis 120, and c) components which are eliminated after analysis 120. In one embodiment of the invention, analysis 120 includes rationalization 140 of component instances from both companies, where the component instance brought over to the new organization includes not only a recommended component from one company but also some assets from the other company. In another embodiment the incorporation of assets associated with discarded components is left to the development of a transformation plan 150.

In a complex merger or acquisition involving a divestiture, an alternative application of the invention would be to include within the component map of the merged company 110 that portion of the business to be divested, including a divestiture plan as part of the transformation plan 150. This alternative may be useful because the CBM model lends itself to partitioning the enterprise, and in particular to partitioning into non-overlapping competencies and components. However, the component map developed under the CBM model represents a “target” state of the business, and the “current state” of the business may not be suitably partitioned to handle a complex merger involving a divestiture. If a portion of the business is to be divested as part of the transformation plan 150, the plan will consider using the CBM model to prepare for the divestiture.

In order for a divestiture of a portion of the business to have the best chance of maintaining the viability of the divested portion as well as to minimize ill effects upon the remaining company, it may be advisable to align the components to be divested with a target component map, as further described in the above referenced foundation patent application. In a complex merger or acquisition involving a divestiture, the strategy for the transaction may well include this alignment as a part of the transformation plan 150. In accordance with the transformation plan 150, an alignment would be followed by steps implementing the divestiture. The invention's application of the CBM methodology accommodates this complexity.

It will be understood by those skilled in the art that this methodology—of creating a target component map for a resulting company and including that map within the target component map of a constituent organization—can also be applied to divestitures and downsizing of a single constituent organization. In its simplest terms, such an application of the invention uses merger and acquisition (or divestiture and downsizing) criteria to develop a “heat map” of components to be included in the divestiture or downsizing.

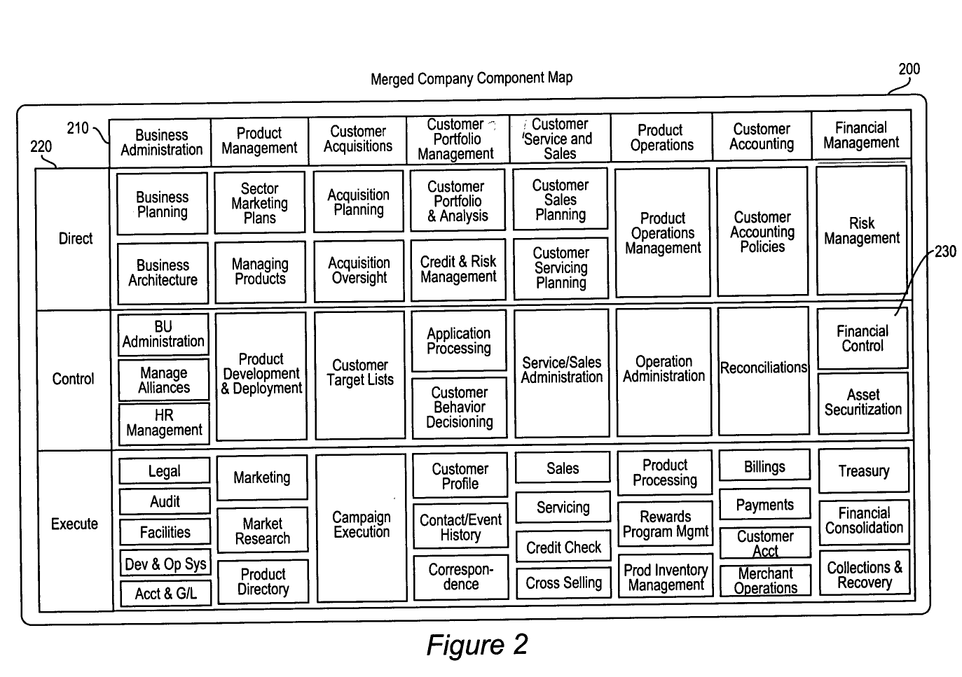

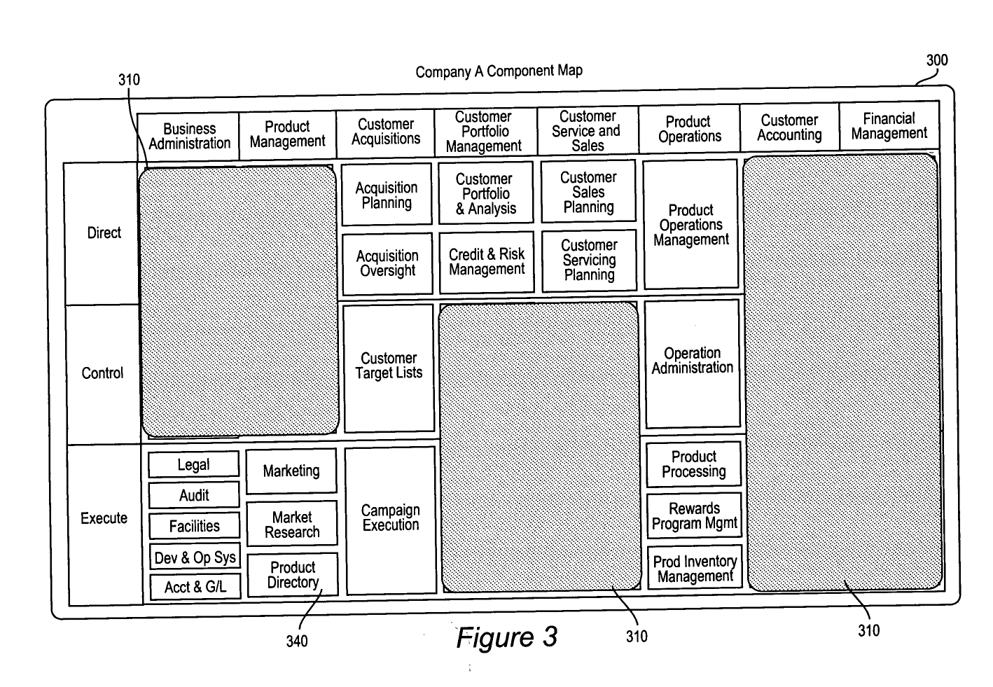

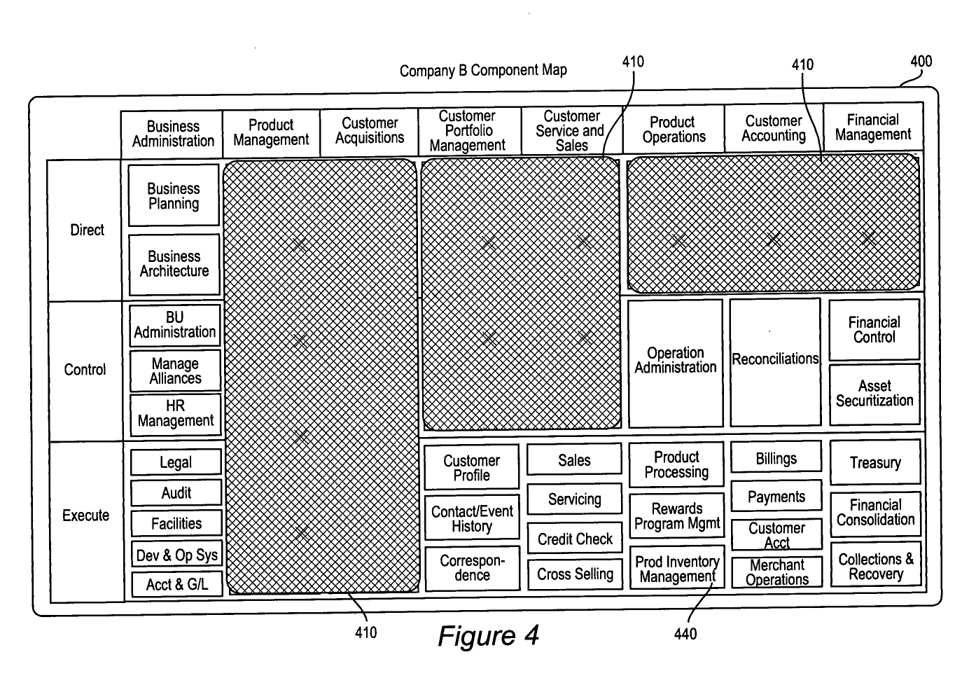

Operation of the invention may further be understood by reference to FIGS. 2 through 5, which provide a simplified conceptual illustration of a merger not involving a divestiture. FIG. 2 shows a target component map 200 of the merged company. The map arrays components (e.g. 230) under competency rows 210 and across management accountability levels 220. FIG. 3 shows a component map 300 of Company A. The current state of Company A contains certain components 310 corresponding to components on the target component map. Similarly, FIG. 4 shows a component map 400 of Company B and the current state of Company B contains certain components 310 corresponding to components on the target component map.

Note that the simplified representations shown in FIGS. 3 and 4 distinguish the current state of Company A from the current state of Company B by reference to components on the target component map. However, as will be understood by those skilled in the art, it is the instantiations of the components that provide the operative detail, both for the target component map 200 and the current state of components in Company A and Company B. For example, the target component map, in response to the strategies for the merged company, may provide for two instantiations for a particular component (e.g. a manufacturing facility for tennis shoes on the west coast and a second manufacturing facility on the east coast for the production of both tennis shoes and laces). Company A's current state may provide the west coast facility and Company B's current state may provide the east coast facility. In this situation there will be no overlap of the instantiations, although both companies have the same component. Or both Company A and Company B may have facilities on the east coast, but only Company B's facility produces both tennis shoes and laces. In this situation there is overlap not only of components but also of the instantiations required for the combined company, and the analysis 120 may result in a recommendation, for example, to include the current state instantiation of Company B in the combined company and exclude the current state instantiation of Company A for the east coast instantiation of the component as described in the target component map.

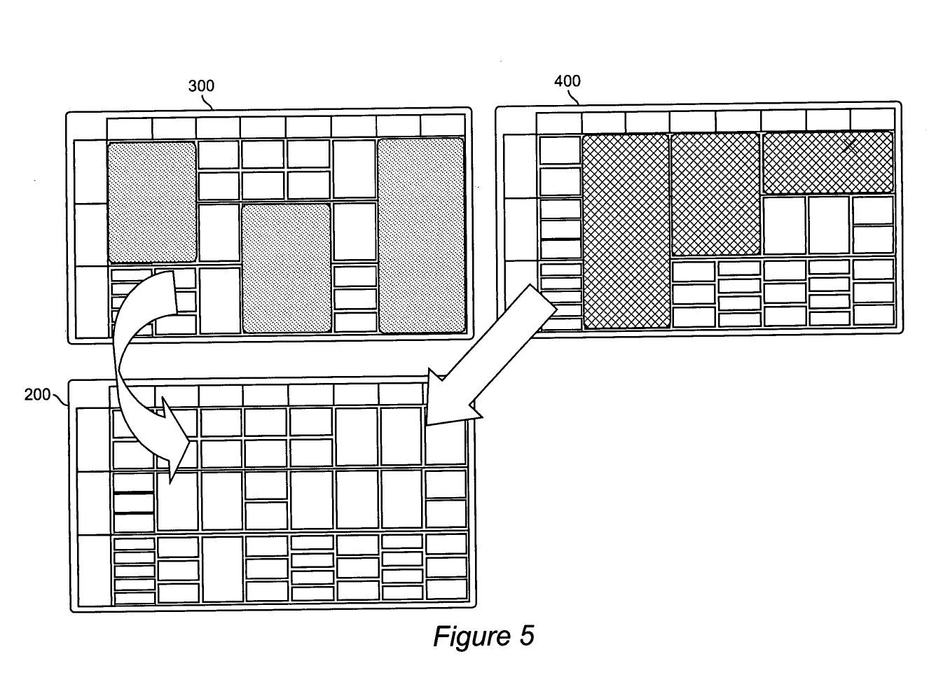

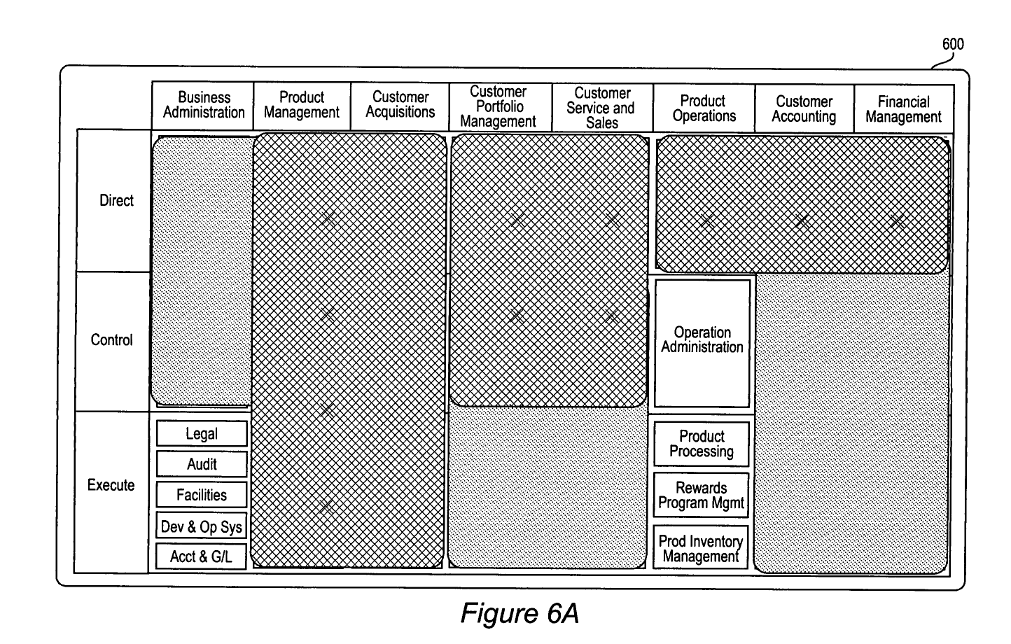

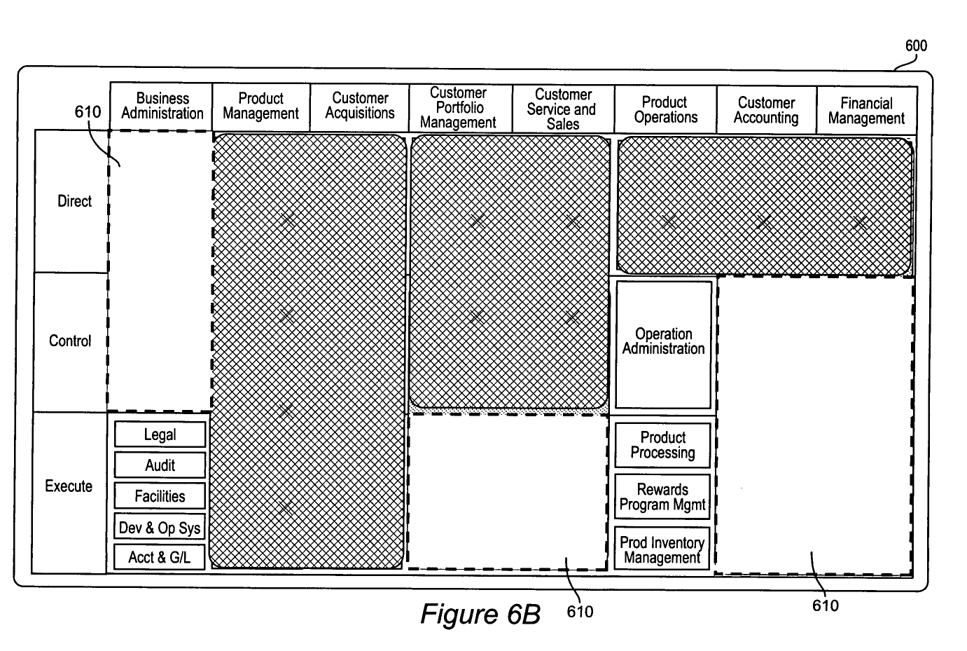

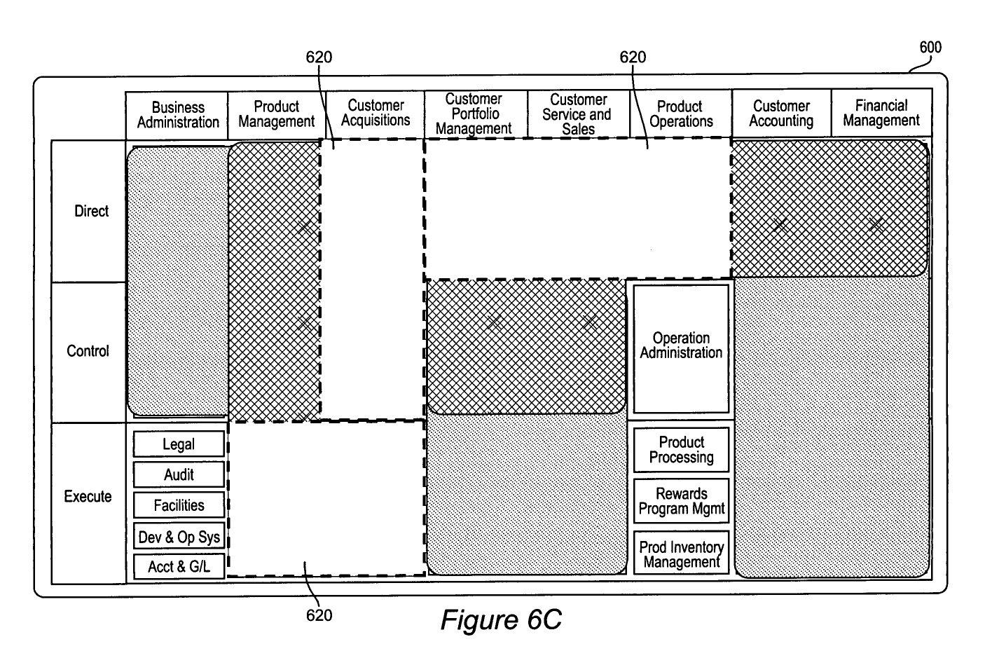

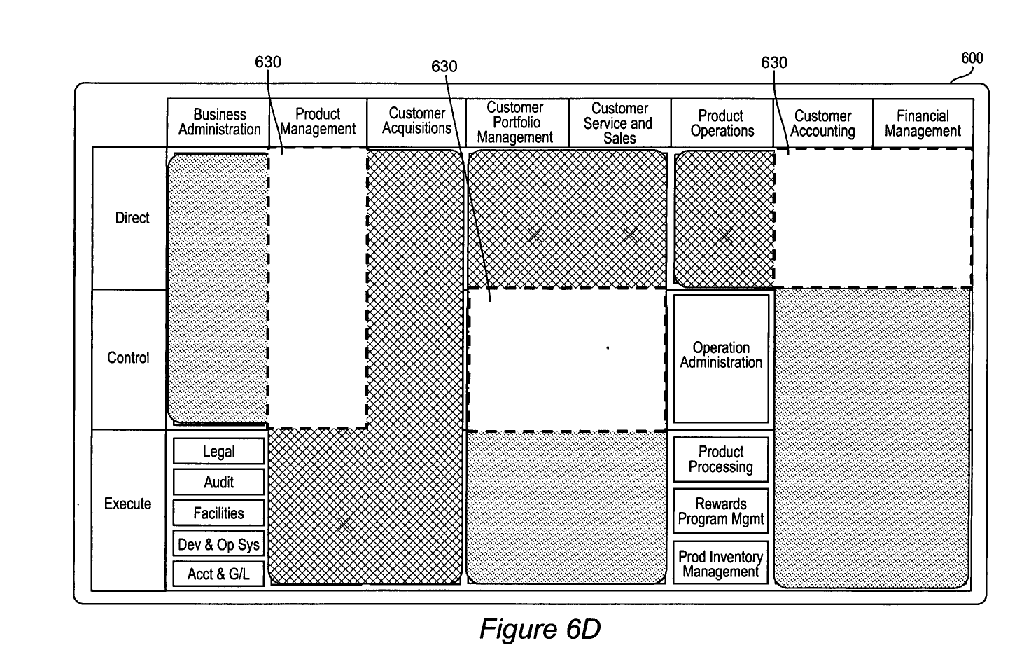

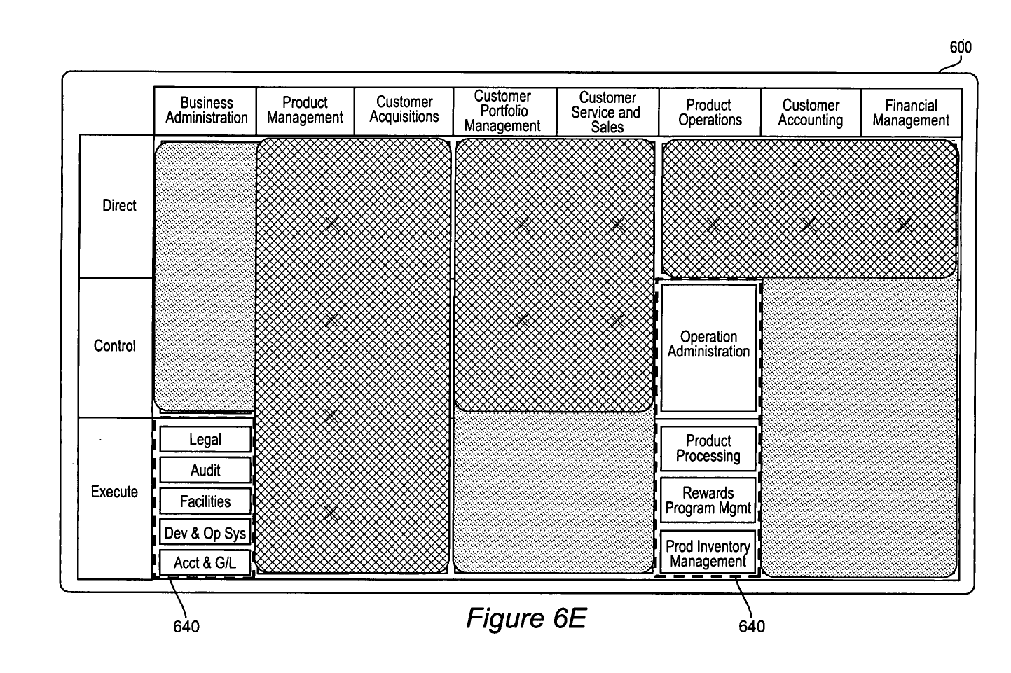

In many instances a component in the target component map may have only a single instantiation, but this distinction between components and instantiations should be kept in mind in considering the conceptual details described below concerning the merger summarized in FIG. 5 between Company A represented by component map 300 and Company B represented by component map 400. The combined company represented by component map 200 is shown as overlapping overlays in component map 600 in FIG. 6A. Those components 610 shown within the dashed lines of FIG. 6B represent those components (i.e., more precisely, component instantiations) of Company A that are required for the combined company and have no counterpart in the component map of Company B. Similarly, those components 620 shown within the dashed lines of FIG. 6C represent those components of Company B that are required for the combined company and have no counterpart in the component map of Company A. These component instantiations 610 and 620 can be carried over to the combined company without a comparative analysis 120, recognizing of course that the transformation plan 150 must account for the difference between the current state of the component instantiation in the constituent company and the target state of the component instantiation in the combined company.

Comparative analysis 120 will be required, however, for those components where the required instantiations in the target component map have corresponding instantiations in the component maps of both Company A and Company B, as shown by those components 630 within the dashed lines on FIG. 6D. Finally, there may be component instantiations required for the combined company that have no corresponding instantiations in either Company A or Company B, as shown by those components 640 within the dashed lines in FIG. 6E. The transformation plan 150 will essentially have to create these component instantiations. It will be noted that all the components (or, more precisely, component instantiations) shown on component map 600 in FIG. 6A are covered in the combination of FIGS. 6B through 6E. It should be noted that in this simplified representation there is no showing of components (and corresponding component instantiations) of Company A or Company B that are present in the constituent companies but are not included in the target component map. Such components would be either discarded 135 without comparative analysis 120, or could be included in a divestiture as described above.

While the invention has been described in terms of preferred embodiments, those skilled in the art will recognize that the invention can be practiced with modification within the spirit and scope of the appended claims.

Having thus described our invention, what we claim as new and desire to secure by Letters Patent is as follows:

1. A method for combining businesses, comprising:
creating a target component map of a resulting company, the map having non-overlapping components each described by attributes in accordance with a strategy for the resulting company;
creating a component map for each of one or more constituent companies, each constituent component map having at least instances of each component of the target map, the respective component instances showing the current state of the constituent company;
analyzing for each component in the target map the corresponding instances of the component in the component map of each said constituent company, recommending one of said instances for inclusion in the combined company; and
generating a plan for transforming said included components into the resulting company.

2. The method of claim 1, wherein said analyzing further comprises:
identifying component instances present in one constituent company but not in the other, said instances being recommended for inclusion without further analysis; and
determining from among constituent companies a “best fit” to component instances of the target map present in both constituent companies, said “best fit” instances being recommended for inclusion.

3. The method of claim 2, wherein “best fit” is determined by a metric based on scored criteria and optimized for target components of the resulting company.

4. The method of claim 1, wherein there are two constituent companies and one is acquiring the other, the acquiring company being the resulting company.

5. The method of claim 1, wherein there are two constituent companies being merged to form the resulting company.

6. The method of claim 1, wherein said analyzing further comprises rationalizing a target component by adding to the recommended component instance from one constituent company assets from the other constituent company.

7. The method of claim 1, wherein said generating further comprises rationalizing a target component by adding to the recommended component instance from one constituent company assets from the other constituent company.

8. The method of claim 1, wherein said target component map of the resulting company includes a portion to be divested from the resulting company.

9. The method of claim 8, wherein the transformation plan includes aligning components of the portion to be divested.

10. The method of claim 9, where there is a single constituent company and the resulting company is downsized by the divestiture.

11. A system for combining businesses, comprising:
means for creating a target component map of a resulting company, the map having non-overlapping components each described by attributes in accordance with a strategy for the resulting company;
means for creating a component map for each of one or more constituent companies, each constituent component map having at least instances of each component of the target map, the respective component instances showing the current state of the constituent company;
means for analyzing for each component in the target map the corresponding instances of the component in the component map of each said constituent company, and for recommending one of said instances for inclusion in the combined company; and
means for generating a plan for transforming said included components into the resulting company.

12. The system of claim 11, wherein said analyzing means further comprises:
means for identifying component instances present in one constituent company but not in the other, said instances being recommended for inclusion without further analysis; and
means for determining from among constituent companies a “best fit” to component instances of the target map present in both constituent companies, said “best fit” instances being recommended for inclusion.

13. The system of claim 12, wherein “best fit” is determined by a metric based on scored criteria and optimized for target components of the resulting company.

14. The system of claim 11, wherein said analyzing means further comprises means for rationalizing a target component by adding to the recommended component instance from one constituent company assets from the other constituent company.

15. The system of claim 11, wherein said generating means further comprises means for rationalizing a target component by adding to the recommended component instance from one constituent company assets from the other constituent company.

16. The system of claim 11, wherein said target component map of the resulting company includes a portion to be divested from the resulting company.

17. Implementing a service for combining businesses, comprising the method of:
creating a target component map of a resulting company, the map having non-overlapping components each described by attributes in accordance with a strategy for the resulting company;
creating a component map for each of one or more constituent companies, each constituent component map having at least instances of each component of the target map, the respective component instances showing the current state of the constituent company;
analyzing for each component in the target map the corresponding instances of the component in the component map of each said constituent company, recommending one of said instances for inclusion in the combined company; and
generating a plan for transforming said included components into the resulting company.

18. The method of implementing a service as in claim 1, wherein said analyzing further comprises:
identifying component instances present in one constituent company but not in the other, said instances being recommended for inclusion without further analysis; and
determining from among constituent companies a “best fit” to component instances of the target map present in both constituent companies, said “best fit” instances being recommended for inclusion.

19. The method of implementing a service as in claim 18, wherein “best fit” is determined by a metric based on scored criteria and optimized for target components of the resulting company.

20. A computer implemented system for combining businesses, comprising:
first computer code for creating a target component map of a resulting company, the map having non-overlapping components each described by attributes in accordance with a strategy for the resulting company;
second computer code for creating a component map for each of one or more constituent companies, each constituent component map having at least instances of each component of the target map, the respective component instances showing the current state of the constituent company;
third computer code for analyzing for each component in the target map the corresponding instances of the component in the component map of each said constituent company, and for recommending one of said instances for inclusion in the combined company; and
fourth computer code for generating a plan for transforming said included components into the resulting company.

21. The computer implemented system of claim 20, wherein said computer code for analyzing further comprises:
fifth computer code for identifying component instances present in one constituent company but not in the other, said instances being recommended for inclusion without further analysis; and
sixth computer code for determining from among constituent companies a “best fit” to component instances of the target map present in both constituent companies, said “best fit” instances being recommended for inclusion.
